(19) United States
(12) Patent Application Publication
(10) Pub. No.: US 2017/0364201 A1
(43) Pub. Date: Dec. 21, 2017

(54) TOUCH-SENSITIVE REMOTE CONTROL

(71) Applicant: Touchplus Information Corp., New Taipei City (TW)

(72) Inventors: Shih-Hsien Hu, New Taipei City (TW); Yi-Feng Wei, New Taipei City (TW); Yao-Chih Chang, Tainan City (TW)

(21) Appl. No.: 15/674,713

(22) Filed: Aug. 11, 2017

Related U.S. Application Data
(63) Continuation-in-part of application No. 14/827,376, filed on Aug. 17, 2015.

(30) Foreign Application Priority Data
Aug. 15, 2014 (CN) 201410401129.3

(51) Int. Cl. G06F 3/041; G06F 3/0488; G06F 3/044

(52) U.S. Cl. CPC G06F 3/0416; G06F 3/044; G06F 3/04883

(57) ABSTRACT

A plurality of controlled devices are allocated in a physical layout. A touch-sensing and displaying panel detects a touching operation or gesture thereon or thereover, generates a position information in response to the touching operation or gesture, and displays a prompt information according to the position information, wherein the touch-sensing and displaying panel has a default virtual prompt layout corresponding to the physical layout of the controlled devices, and consisting of a plurality of default prompts, and the prompt information includes a prompt pattern consisting of a selected portion of the default prompts, and is changeable with the position information generated in response to the touching operation or gesture. A driver issues a first driving signal to the controlled system according to the position information for triggering a selected group of the controlled devices in compliance with the prompt pattern.

### CROSS-REFERENCE TO RELATED APPLICATIONS

The present application is a continuation-in-part application claiming benefit from a pending U.S. patent application bearing a Ser. No. 14/827,376 and filed Aug. 17, 2015, contents of which are incorporated herein for reference.

### FIELD OF THE INVENTION

The present invention relates to a touch-sensitive control device, and more particularly to a touch-sensitive control device supporting remote control. The present invention also relates to a touch-sensitive remote-control system.

### BACKGROUND OF THE INVENTION

With the development of interactive electronic devices, particularly portable electronic communication devices such as smart phones and tablet computers, touch-sensing is more and more popular as a human-machine interface contributed to the intuitive and easy manipulation features. So far, capacitive touch sensors have been the mainstream of touch sensors.

For devices controlled with switch buttons or keys, the mechanical structures are disadvantageous in compactness and maintenance. Furthermore, if the devices are distributed in a relatively large area and need to be group controlled, the control via a mechanical interface would be difficult. Therefore, a touch-sensitive control device is advantageously applied to a remote-control system.

For example, US Patent Publication No. 2015/0341184 A1 discloses a control device, which may execute an application that presents a custom UI to a user, and relays control commands back to the host controller of a home automation system. A conversion engine may convert a service implementation into a configuration database, a copy of which may also be maintained on the host controller. The configuration database utilizes special logical representations to describe the configuration of the home automation system. To produce a custom UI on a given control device, the configuration database is transferred to (e.g., downloaded by) the control device and encapsulated by a control SDK. The control SDK, among other functionality, provides methods for querying the configuration database. A mobile app executing on the control device utilizes the control SDK to systematically query the configuration database, to retrieve information concerning the logical representations (present and thereby the configuration of the home automation system. The mobile app then translates returned information to UI elements to create a custom UI of the mobile app, the translation using predefined mappings. The custom UI is displayed on the control device, for use by a user to control the home automation system. The above-described UI elements of the custom UI are shown on the display as a listing of sliders, buttons or knobs, and are user-selectable to indicate desired control of the related entities.

Another US Patent Publication No. 2014/0098247 proposes smart home control using mobile devices, cellular telephones, smart devices and smart phones. Activities in the house may be viewed on the Mobile Device/Mobile Phone including the current state of various appliances, events, and authorized users with permissions to control and access various appliances. Events may be searched, assigned to, or organized by user in the household. Temporary access to the house or an appliance may be enabled by adding a user and setting a duration of access. The location of the individuals may be mapped, geo-fenced, and determined using GPS, Access Point connections and names and locations, network IP address, RFID, NEC, or other location mapping techniques. Each appliance may be mapped to a specific location in the house or office and identified with a description, photo, or internal home map. A slider bar may allow a user to dim lights by making contact with the screen and moving the slider bar from one end to the other.

In the above-described systems, the controlled elements are operated individually. That is, one element is selected and controlled at one time by triggering and moving a corresponding slider bar. Such control mechanisms do not actually take advantage of capabilities of touch-sensing control.

### SUMMARY OF THE INVENTION

Therefore, the present invention provides a touch-sensitive control device supporting remote control in an intuitive and flexible way.

The present invention further provides touch-sensitive control device supporting remote control in a grouped manner.

The present invention provides a control device for controlling a controlled system, which includes a plurality of controlled devices allocated in a physical layout. The control device comprises a touch-sensing and displaying panel detecting a touching operation or gesture thereon or thereover, generating a position information in response to the touching operation or gesture, and displaying a prompt information according to the position information, wherein the touch-sensing and displaying panel has a default virtual prompt layout corresponding to the physical layout of the controlled devices, and consisting of a plurality of default prompts, and the prompt information includes a prompt pattern consisting of a selected portion of the default prompts, and is changeable with the position information generated in response to the touching operation or gesture; and a driver in communication with the touch-sensing and displaying panel and the controlled system, issuing a first driving signal to the controlled system according to the position information for triggering a selected group of the controlled devices in compliance with the prompt pattern.

In an embodiment, the default virtual prompt layout is consistent to the physical layout of the controlled devices.

In an embodiment, the selected group of the controlled devices are simultaneously controlled by another touching operation or gesture on or over the touch-sensing and displaying panel.

In an embodiment, the touching operation or gesture includes multiple moves simultaneously or sequentially conducted at multiple positions on or over the touch-sensing and displaying panel to select the default prompts. Alternatively, the touching operation or gesture passes some of the default prompts to define a closed loop so as to have the default prompts located inside the closed loop automatically selected. Preferably, the automatically selection of certain default prompts can be manually cancelled by a further touching operation or gesture thereon or thereover.

In an embodiment, the controlled devices are allocated as an array, and are selected from a group consisting of lamps, sprinklers, electrochromic members and electric curtains, and the touch-sensing and displaying panel includes an LED array adaptively emitting light to show the prompt pattern.

In an embodiment, the prompt pattern is a pictorial and/or literal pattern.

According to the present invention, a user can clearly identify the relative positions of the near-end control device and the remote-end controlled devices, thereby supporting remote control by way of touch-sensing means. The operation interface is easy, flexible and intuitive, and the structure is simplified.

### RIEF DESCRIPTION OF THE DRAWINGS

The invention will become more readily apparent to those ordinarily skilled in the art after reviewing the following detailed description and accompanying drawings, in which:

FIG. 1 is scheme illustrating a remote control between a touch-sensing control device and a controlled system according to an embodiment of the present invention;

FIG. 2A is a schematic diagram illustrating an example of correspondence of a default virtual layout of default prompts to a physical layout of controlled devices;

FIG. 2B is a schematic diagram illustrating another example of correspondence of a default virtual layout of default prompts to a physical layout of controlled devices;

FIG. 2C is a schematic diagram illustrating an example of prompt pattern derived from the virtual layout of FIG. 2B;

FIG. 2D is a schematic diagram illustrating another example of prompt pattern derived from the virtual layout of FIG. 2B;

FIG. 2E is a schematic diagram illustrating a further example of prompt pattern derived from the virtual layout of FIG. 2A;

FIG. 3 is a scheme illustrating an operation of the touch-sensing control device for remote control of the controlled system in an example of the embodiment as shown in FIG. 1; and

FIG. 4 is a scheme illustrating an operation of the touch-sensing control device for remote control of the controlled system in another example of the embodiment as shown in FIG. 1.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

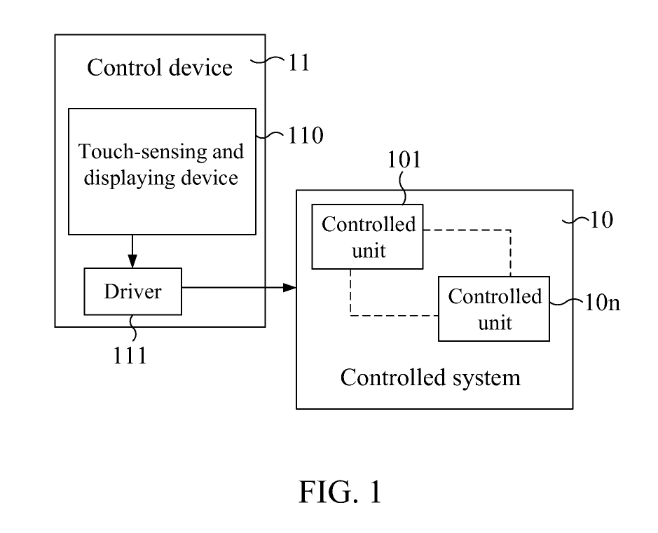

Referring to FIG. 1, a touch-sensing control device 11 according to an embodiment of the present invention is used to remotely control a controlled system 10, which includes a plurality of controlled units 101˜10n. The control device 11 includes a touch-sensing and displaying panel 110 and a driver 111. The touch-sensing and displaying panel 110 senses a user's touching operation or gesture thereon or thereover so as to generate a position information, or senses a series of user's touching operations or gestures thereon or thereover so as to generate a set of position information. It is to be noted that the term “touch-sensitive” or “touch-sensing” means not only to be sensitive to a sliding or touching gesture actually acting on a specified surface but also sensitive to an air gesture floatingly acting over the specified surface. The air gesture may be a vertically moving action and/or a horizontally moving action within a specified range, or a holding-still action for a specified period of time. Hereinafter, fingers are exemplified as the tool for executing the gestures. However, any other suitable tool capable of conducting a capacitance change may be used depending on practical requirements and size of the touch-sensing electronic device. For example, palms or conductive objects may also be used instead. For large-area touch sensing, a plurality of touch sensing units may be combined to detect a capacitance change so as to effectively enhance the sensitivity and effective sensible distance.

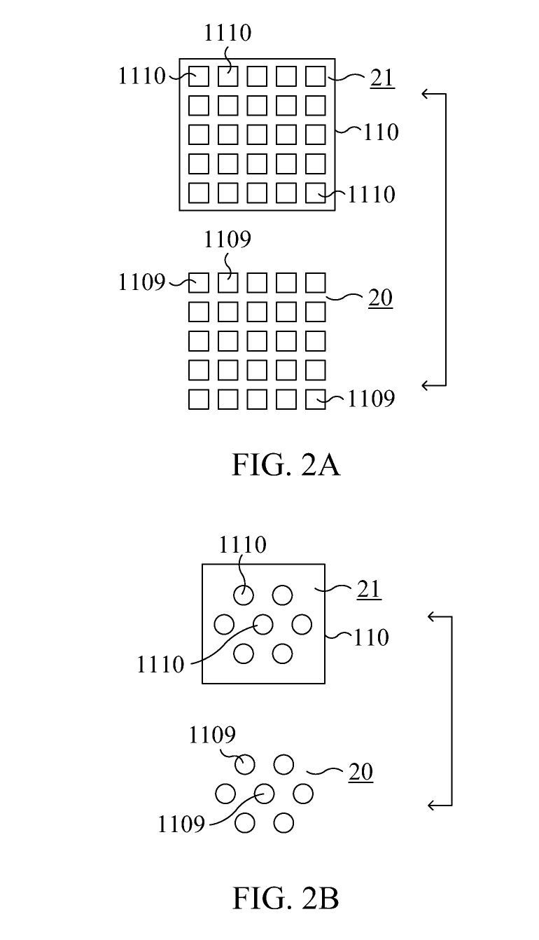

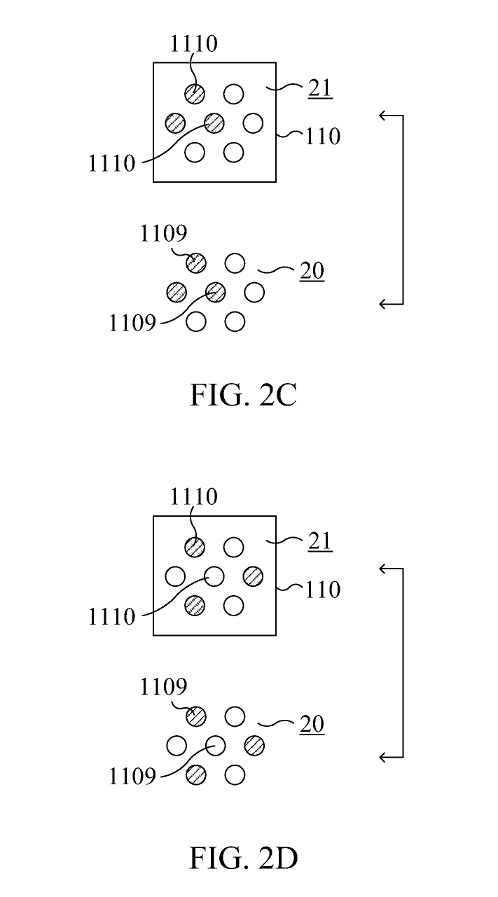

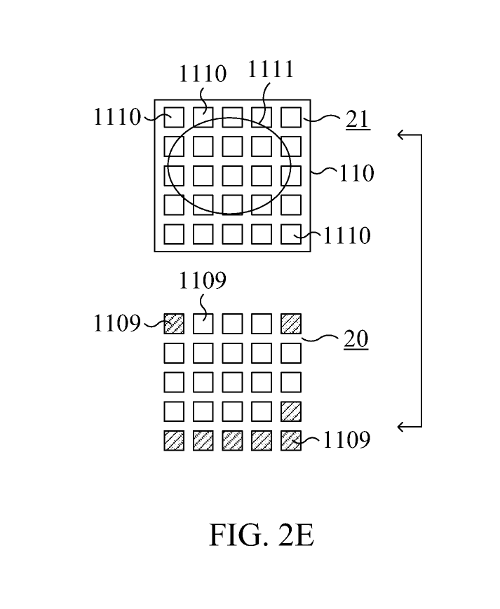

The controlled units 101˜10n may be allocated as an array or in any other form, depending on practical requirements. The controlled units 101˜10n may be similar or different devices. Even if the controlled units 101˜10n are identical, they can still be readily identified according to the present invention, compared to the prior art. The touch-sensing and displaying panel 110 of the touch-sensing control device 11 according to the present invention has a default virtual layout 21 consisting of a plurality of default prompts, which corresponds to the physical layout 20 consisting of the controlled units 101˜10n. In an embodiment, the default virtual layout 21 is consistent or equivalent to the physical layout 20, as illustrated in FIG. 2A or 2B, wherein each element or element assembly 1109 included in the physical layout 20 exclusively corresponds to one exclusive one prompt 1110 included in the virtual layout 21. In an embodiment, when selected one or more of the controlled units 101˜10n are to be activated or controlled, only the corresponding prompts are displayed, highlighted or color-changed to form a prompt pattern. For example, the selection may be conducted by way of a touch operation or gesture, which may include multiple moves simultaneously or sequentially conducted at multiple positions on or over the touch-sensing and displaying panel 110, thereby forming the prompt pattern. A variety of prompt patterns may be created as desired by differentially selecting prompts. FIG. 2C and FIG. 2D illustrate two examples of prompt patterns originated from the layout of FIG. 2B. The dark (shaded) prompts represent unselected ones, while the bright prompts indicate those selected in response to the moves.

FIG. 2E schematically illustrates another example of prompt patterns originated from the layout of FIG. 2A. In this embodiment, the touching operation or gesture is a continuous sliding operation or gesture passing some of the default prompts 1110 to define a closed loop 1111 so as to have the default prompts 1110 located inside the closed loop 1111 automatically selected. Accordingly, those elements or element assemblies 1109 corresponding to the selected prompts 1110 are enabled, as indicated by the bright ones, while the others are kept disabled, as indicated by the dark (shaded) ones. Preferably, the automatically selection of certain default prompts can be manually cancelled by a further touching operation or gesture thereon or thereover.

According to the position information or the set of position information, a prompt information will be displayed on the panel 110. The prompt information may include one or more pictorial and/or literal patterns. Meanwhile, the driver 111, which is in communication with the touch-sensing and displaying panel 110 and the controlled system 10, issues a first driving signal to the controlled system 10 according to the position information or the set of position information, thereby driving one or more of the controlled units 101˜10n associated with the displayed pattern or patterns to conduct a specific operation. For example, in response to a user's touching operation or gesture, a corresponding position information is generated and a prompt pattern 21 is displayed on the display 110. The prompt pattern 21 is preset to correspond to selected controlled units. Accordingly, the driver 111 issues a driving signal to enable a default action of the controlled units.

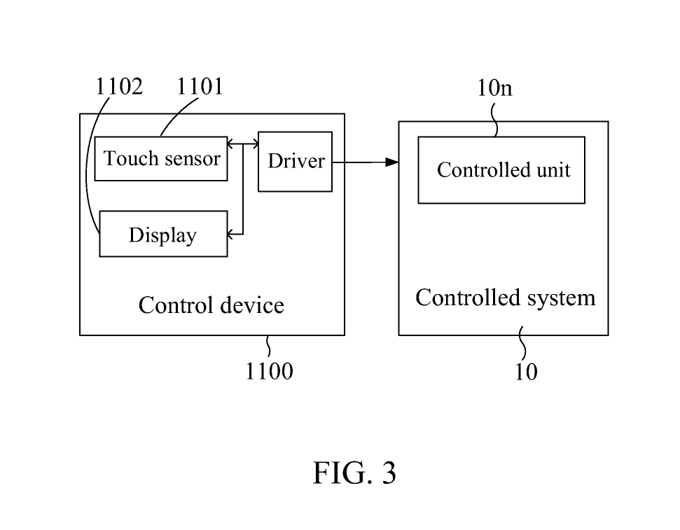

FIG. 3 is a scheme illustrating an operation of the touch-sensing control device for remote control of the controlled system in an example of the embodiment as shown in FIG. 1. The touch-sensing and displaying panel 110 includes a housing 1100, a touch sensor 1101 and a display 1102. The touch sensor 1101 and the display 1102 are integrated into the housing 1100 or onto a surface of the housing 1100. The touch sensor 1101 senses a user's touching operation or gesture on or over the housing 1100 so as to generate a position information. Meanwhile, a prompt information is generated and shown at a specific position on the display 1102 corresponding to the position information. For example, the touch sensor can be a capacitive touch sensor; and the display 1102 can be a planar display such as a light-emitting diode (LED) array or a liquid crystal display (LCD). In a specific example, the touch sensor 1101 and the display 1102 may overlap with each other. Accordingly, when a user conducts a touching operation or gesture on or over the housing 110 at a right lower corner, the touch sensor 1101 realizes the sensed location, generating a position information based on the sensed location, and transmits the position information to the display 1102 and the driver 111. The display 1102 shows a prompt information, e.g. a prompt pattern 21, at a specific position according to the position information, and the driver 111 issues a first driving signal to the controlled system 10 according to the position information so as to trigger one or more of the controlled units corresponding to the specific position of the prompt pattern 21. The prompt information is shown on the display 1102 for prompting the user of the triggered controlled unit or units.

In this example, the controlled units 101˜10n can be lamps, and selectively triggered to illuminate in a variety of combinations under the control of the control device 11 as described above.

Extensively, the selected controlled unit or units or all the controlled units can be fine-tuned, as a whole, by the control device 11 based on another user's touching operation or gesture. For example, in response to sliding operation or gesture, the touch sensor generates a shift information. The driver 111 issues a second driving signal to the controlled system 10 to trigger the fine-tuning according to the shift information. For example, when the touch sensor 1101 detects a sliding shift from right to left in a specified or designated region, a corresponding shift information is generated. The driver 111 receives the shift information and in response, issues a driving signal to the controlled system 10 to trigger a fine-tuning operation of the controlled system, e.g. to raise the luminance of all or selected lamp or lamps. On the contrary, when the touch sensor 1101 detects a sliding shift from left to right in the specified or designated region, a corresponding shift information is generated. The driver 111 receives the shift information and in response, issues a driving signal to the controlled system 10 to trigger another fine-tuning operation of the controlled system, e.g. to lower the luminance of all or selected lamp or lamps.

In another example, when the touch sensor 1101 detects a downward sliding shift in the specified or designated region, a corresponding shift information is generated. The driver 111 receives the shift information and in response, issues a driving signal to the controlled system 10 to trigger a fine-tuning operation of the controlled system, e.g. to raise the color temperature of all or selected lamp or lamps. On the contrary, when the touch sensor 1101 detects an upward sliding shift in the specified or designated region, a corresponding shift information is generated. The driver 111 receives the shift information and in response, issues a driving signal to the controlled system 10 to trigger another fine-tuning operation of the controlled system, e.g. to lower the color temperature of all or selected lamp or lamps. The upward or downward sliding shift described herein may be a horizontal shift in parallel to the housing surface of the control device 10. Alternatively, with a specifically designed touch sensor, the upward or downward sliding shift described herein may also be a vertical shift normal to the housing surface of the control device 10.

Further extensively, a mode of the selected controlled unit or units or all the controlled units can be switched, as a whole, by the control device 11 based on another user's touching operation or gesture. For example, in response to a tapping operation or gesture, the touch sensor generates a count information. The driver 111 issues a third driving signal to the controlled system 10 to trigger the mode-switching according to the count information. For example, when the touch sensor 1101 detects a specified count of tapping, a corresponding count information is generated. The driver 111 receives the count information and in response, issues a driving signal to the controlled system 10 to trigger a mode-switching operation of the controlled system, e.g. to change colors of all or selected lamp or lamps. For example, different tapping counts and/or sequences result in different default colors.

Further extensively, a specific mode of the selected controlled unit or units or all the controlled units can be triggered, as a whole, by the control device 11 based on another user's touching operation or gesture. For example, a power-on or power-off control or power level control of the selected controlled unit or units or all the controlled units as a whole can be triggered by the control device 11 based on another user's touching operation or gesture. For example, in response to a pressing operation or gesture, the touch sensor generates a duration information. The driver 111 issues a fourth driving signal to the controlled system 10 to trigger the power-switching or power-adjusting operation according to the duration information. For example, when the touch sensor 1101 detects a pressing duration exceeding a threshold, a corresponding duration information is generated. The driver 111 receives the duration information and in response, issues a driving signal to the controlled system 10 to trigger a power-switching operation of the controlled system, e.g. to power on or power off all or selected lamp or lamps, or to change supplied power level of all or selected lamp or lamps.

In addition to lamps, the controlled units may also be, for example, sprinklers, electrochromic glass members, electric curtains or any other suitable devices or members to be group-controlled. According to the present invention, due to the clear position correlation of the controlled system to the control device, remote control of the controlled system can be achieved by conducting a touching operation or gesture on or over the control device. The remote control may include simple switch-on and switch-off operations. Furthermore, a variety of fine-tuning operations may also be included by way of corresponding designs. The parameters to be fine-tuned, for example, may include a sprayed water level of all or selected sprinkler or sprinklers, transmittance of all or selected electrochromic glass member or members, an open level of all or selected electric curtain or curtains, etc. The fine-tuning operations are conducted according to shift information generated in response to user's sliding shifts, as mentioned above. Likewise, prompt pattern or patterns generated in response to user's touching operation(s) or gesture(s) and corresponding to the selected controlled unit or units are shown on the display for reference or confirmation.

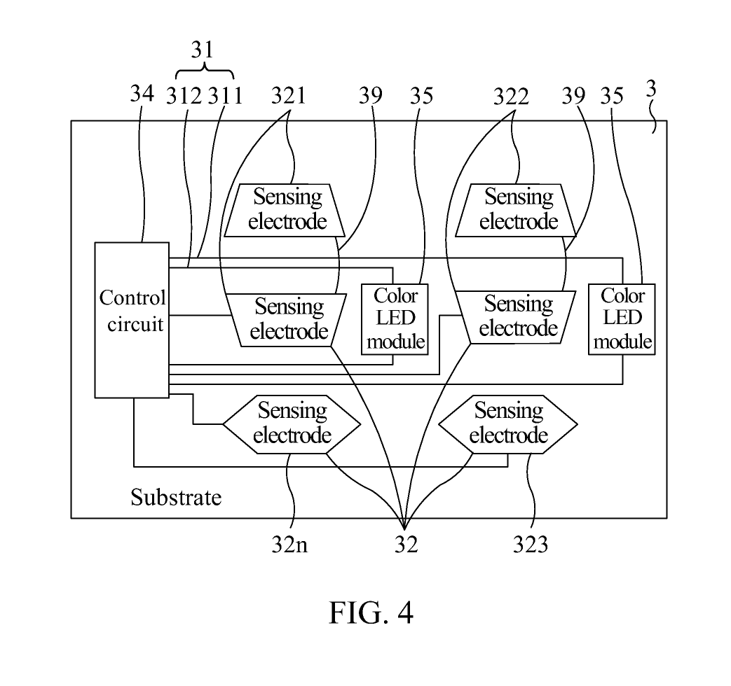

The touch-sensing and displaying panel 110 may alternatively be implemented with a structure as shown in FIG. 4. As shown, a first conductive structure 31 and a second conductive structure 32 are formed on the same surface of a substrate 3. The substrate 3 may be disposed on a surface of the housing 1100. Alternatively, the substrate 3 may be partially or entirely packed by the housing material by way of, for example, injection molding or any other suitable packaging technique, so as to be inserted inside the material of the housing 1100. The substrate 3 may be a single-layer single-face circuit board which is advantageous in low cost and simple manufacturing process. Of course, it can also be a single-layer double-face circuit board, or any other substrate adapted for the objectives of the present invention. The circuitry formed on the substrate 3 includes a control circuit 34 and one or more color LED modules 35 in addition to the first conductive structure 31 and the second conductive structure 32. One or more color LED modules 35 are electrically coupled to the first conductive structure 31 to receive power supply and control signals from the control circuit 34. The second conductive structure 32 includes a plurality of sensing electrodes 321˜32n typically arranged as one or more arrays for touch sensing. The second conductive structure 32 should be electrically isolated from the first conductive structure 31. Therefore, at the intersections of the sensing electrodes 321˜32n and power lines 311 and 312 associated with the first conductive structure 31, jumper wires 39 may be used for connecting the sensing electrodes. The jumper wires 39 may be provided onto the surface of the substrate 3 together with the color LED modules 35 in the same process or method, e.g. by way of surface mounting technology (SMT). Alternatively, other suitable means which electrically interconnects the sensing electrodes while electrically isolating the sensing electrodes 321˜32n from the power lines 311 and 312 may also be used, or the connecting lines between the sensing electrodes may just bypass the power lines 311 and 312, or the power lines 311 and 312 may bypass the sensing electrodes 321˜32n. If a single-layer double-face circuit board is used, via hole electric conduction may also be adopted. The number of the color LED modules depends on the distribution of the sensing electrodes in order that the control circuit 34 can calculate the position information and the shift information according to the sensed capacitance change of the sensing electrodes 321˜32n. Under this configuration, for example, one or more color LED modules 35 are turned on according to one or more corresponding touch-sensed points. A shift information may be generated in response to a sliding shift of a user on or over the touch-sensing and displaying panel. One or more parameters, e.g. brightness or color, then change according to the shift information. Afterwards, another touching operation or gesture, e.g. double clicks, may be performed to transmit the settings to the controlled system 10 via the driver 111.

In view of the foregoing, by corresponding the configuration of the near-end control device to the layout of the remote-end controlled system, remote control can be achieved via an easy and intuitive touch-sensing interface according to the present invention. Furthermore, the touch-sensing interface exempts from bulky and damage problems generally encountered by a mechanical structure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control device for controlling a controlled system, the controlled system including a plurality of controlled devices allocated in a physical layout, the control device comprising:
a touch-sensing and displaying panel detecting a touching operation or gesture thereon or thereover, generating a position information in response to the touching operation or gesture, and displaying a prompt information according to the position information, wherein the touch-sensing and displaying panel has a default virtual prompt layout corresponding to the physical layout of the controlled devices, and consisting of a plurality of default prompts, and the prompt information includes a prompt pattern consisting of a selected portion of the default prompts, and is changeable with the position information generated in response to the touching operation or gesture; and
a driver in communication with the touch-sensing and displaying panel and the controlled system, issuing a first driving signal to the controlled system according to the position information for triggering a selected group of the controlled devices in compliance with the prompt pattern.

2. The control device according to claim 1, wherein the default virtual prompt layout is consistent to the physical layout of the controlled devices.

3. The control device according to claim 1, wherein the selected group of the controlled devices are simultaneously controlled by another touching operation or gesture on or over the touch-sensing and displaying panel.

4. The control device according to claim 3, wherein the another touching operation or gesture includes a sliding operation, the touch-sensing and displaying panel further generates a shift information in response to the sliding operation or gesture, and the driver issues a second driving signal to the controlled system according to the shift information for driving the controlled system to conduct a fine-tuning operation.

5. The control device according to claim 3, wherein the another touching operation or gesture includes a tapping operation, the touch-sensing and displaying panel further generates a count information in response to the tapping operation or gesture, and the driver issues a third driving signal to the controlled system according to the count information for driving the controlled system to conduct a mode-switching operation.

6. The control device according to claim 3, wherein the another touching operation or gesture includes a pressing operation, the touch-sensing and displaying panel further generates a duration information in response to the pressing operation or gesture, and the driver issues a fourth driving signal to the controlled system according to the duration information for driving the controlled system to conduct a mode-triggering operation.

7. The control device according to claim 1, wherein the touch-sensing and displaying panel includes:
a housing;
a touch sensor detecting the touching operation or gesture thereon or thereover, and generating the position information in response to the touching operation or gesture; and
a display integrated into the housing together with the touch sensor and displaying the prompt information according to the position information.

8. The control device according to claim 7, wherein the touch sensor is a capacitive touch sensor and the display is an LED array or an LCD display.

9. The control device according to claim 1, wherein the controlled devices are allocated as an array, and are selected from a group consisting of lamps, sprinklers, electrochromic members and electric curtains, and the touch-sensing and displaying panel includes an LED array adaptively emitting light to show the prompt pattern.

10. The control device according to claim 1, wherein the prompt pattern is a pictorial and/or literal pattern.

11. The control device according to claim 1, wherein the selected portion of the default prompts is displayed, highlighted or color-changed in response to the touching operation or gesture.

12. The control device according to claim 1, wherein the touch-sensing and displaying panel includes:
a touch sensor detecting the touching operation or gesture thereon or thereover, and generating the position information in response to the touching operation or gesture; and
at least one light-emitting module disposed adjacent to the touch sensor, and selectively emitting light according to the position information.

13. The control device according to claim 1, wherein the touching operation or gesture includes multiple moves simultaneously or sequentially conducted at multiple positions on or over the touch-sensing and displaying panel to select the default prompts.

14. The control device according to claim 1, wherein the touching operation or gesture passes some of the default prompts to define a closed loop so as to have the default prompts located inside the closed loop automatically selected.

15. The control device according to claim 14, wherein the automatically selected default prompts is removable by a further touching operation or gesture thereon or thereover.
